(19) United States
(12) Patent Application Publication
(10) Pub. No.: US 2021/0406329 A1
(43) Pub. Date: Dec. 30, 2021

(54) QUESTION ANSWERING PROCESSING METHOD AND APPARATUS, AND STORAGE MEDIUM

(71) Applicant: BAIDU ONLINE NETWORK TECHNOLOGY (BEIJING) CO., LTD., Beijing (CN)

(72) Inventor: Taotao ZHAO, Beijing (CN)

(21) Appl. No.: 17/092,064

(22) Filed: Nov. 6, 2020

(30) Foreign Application Priority Data
Jun. 29, 2020 (CN) 202010608522.5

(51) Int. Cl. G06F 16/9537; G06F 16/2457; G06F 16/9032

(52) U.S. Cl. CPC G06F 16/9537; G06F 16/90332; G06F 16/24578

(57) ABSTRACT

A question answering processing method and apparatus, and a storage medium is disclosed herein. The detailed implementation solution includes: receiving a speech question inputted by a user; obtaining an answer set corresponding to the speech question, the answer set including a plurality of candidate answers, and each candidate answer corresponding to a region identification; obtaining a current region identification of the user, and determining whether the answer set includes the current region identification; and in a case that the answer set includes the current region identification, obtaining a first candidate answer corresponding to the current region identification, and feeding the plurality of candidate answers sorted with the first candidate answer as a first place back to the user.

### CROSS-REFERENCE TO RELATED APPLICATION

The present application is based upon and claims priority to Chinese Patent Application No. 202010608522.5, filed on Jun. 29, 2020, the entire contents of which are incorporated herein by reference.

### FIELD

The present disclosure relates to fields of artificial intelligence, speech technology and deep learning of data processing technologies, more particularly to a question answering processing method and apparatus, and a storage medium.

### BACKGROUND

Presently, with the continuous development of the Internet and intelligent device technology, there are more and more interactions between a user and an intelligent device. Users in different regions may need different results returned for a same question. For example, “how to cook tofu pudding?” If a method for sweet tofu pudding is returned, users in southern regions may feel satisfied, but users in northern regions may feel dissatisfied.

### SUMMARY

The present disclosure provides a question answering processing method and apparatus, and a storage medium.

According to embodiments of the present disclosure, there is provided a question answering processing method. The method includes: receiving a speech question inputted by a user; obtaining an answer set corresponding to the speech question, the answer set including a plurality of candidate answers, and each candidate answer corresponding to a region identification; obtaining a current region identification of the user, and determining whether the answer set comprises the current region identification; and in a case that the answer set includes the current region identification, obtaining a first candidate answer corresponding to the current region identification, and feeding the plurality of candidate answers sorted with the first candidate answer as a first place back to the user.

According to embodiments of the present disclosure, there is provided a question answering processing apparatus. The apparatus includes a non-transitory computer-readable medium including computer-executable instructions stored thereon, and an instruction execution system which is configured by the instructions to implement: a receiving module, an obtaining module, an obtaining and determining module, and an obtaining and feedback module. The receiving module is configured to receive a speech question inputted by a user. The obtaining module is configured to obtain an answer set corresponding to the speech question, the answer set including a plurality of candidate answers, and each candidate answer corresponding to a region identification. The obtaining and determining module is configured to obtain a current region identification of the user, and to determine whether the answer set includes the current region identification. The obtaining and feedback module is configured to obtain a first candidate answer corresponding to the current region identification in a case that the answer set includes the current region identification, and to feed the plurality of candidate answers sorted with the first candidate answer as a first place back to the user.

Embodiments of the present disclosure provide a non-transitory computer readable storage medium having computer instructions stored thereon. When the computer instructions are executed by a processor in a computer, the processor is caused to implement a question answering processing method. The method may include: receiving a speech question inputted by a user; obtaining an answer set corresponding to the speech question, the answer set including a plurality of candidate answers, and each candidate answer corresponding to a region identification; obtaining a current region identification of the user, and determining whether the answer set comprises the current region identification; and in a case that the answer set comprises the current region identification, obtaining a first candidate answer corresponding to the current region identification, and feeding the plurality of candidate answers sorted with the first candidate answer as a first place back to the user.

It should be understood that contents described in this section are not intended to identify key or important features of embodiments of the present disclosure, nor are they intended to limit the scope of the present disclosure. Other features of the present disclosure may become apparent from the following description.

### BRIEF DESCRIPTION OF THE DRAWINGS

The accompanying drawings are used for better understanding the solution and do not constitute a limitation of the present disclosure.

FIG. 1 is a flow chart illustrating a question answering processing method according to a first embodiment of the present disclosure.

FIG. 2 is a flow chart illustrating a question answering processing method according to a second embodiment of the present disclosure.

FIG. 3 is a flow chart illustrating a question answering processing method according to a third embodiment of the present disclosure.

FIG. 4 is a block diagram illustrating a question answering processing apparatus according to a fourth embodiment of the present disclosure.

FIG. 5 is a block diagram illustrating a question answering processing apparatus according to a fifth embodiment of the present disclosure.

FIG. 6 is a block diagram illustrating a question answering processing apparatus according to a sixth embodiment of the present disclosure.

FIG. 7 is a block diagram illustrating a question answering processing apparatus according to a seventh embodiment of the present disclosure.

FIG. 8 is a block diagram illustrating an electronic device capable of implementing a question answering processing method according to embodiments of the present disclosure.

### DETAILED DESCRIPTION

Description will be made below of exemplary embodiments of the present disclosure with reference to accompanying drawings, which includes various details of embodiments of the present disclosure to facilitate understanding and should be regarded as merely exemplary. Therefore, it should be recognized by those skilled in the art that various changes and modifications may be made to the embodiments described herein without departing from the scope and spirit of the present disclosure. Meanwhile, for clarity and conciseness, descriptions for well-known functions and structures are omitted in the following description.

Description will be made below to a question answering processing method and apparatus, an electronic device, and a storage medium according to embodiments of the present disclosure with reference to accompanying drawings.

FIG. 1 is a flow chart illustrating a question answering processing method according to a first embodiment of the present disclosure.

In a practical application scene, users in different regions may need different results returned for a same question when interacting with an intelligent device such as an intelligent speaker. For example, for “how to cook tofu pudding”, “how to make a rice dumpling”, etc., the intelligent speaker needs to give feedback to the users more intelligently.

With the question answering processing method provided by the present disclosure, an answer may be fed back to the user based on a region to which the user belongs when using the intelligent device, and a weight of the answer is automatically adjusted, thereby improving the intelligence of the intelligent device.

In detail, as illustrated in FIG. 1, the question answering processing method may include the following.

At block S101, a speech question inputted by a user is received.

At block S102, an answer set corresponding to the speech question is obtained, the answer set including a plurality of candidate answers, and each candidate answer corresponding to a region identification.

The question answering processing method may be applied to an electronic device which may perform speech interaction with the user, such as an intelligent speaker and an intelligent phone.

In this embodiment of the present disclosure, the speech question inputted by the user may be received, such as “how to cook tofu pudding” or “how to make a dumpling”. The user may select and input a corresponding speech question based on a specific usage scene.

In this embodiment of the present disclosure, there are a plurality of ways for receiving the speech question inputted by the user. As a scene example, the speech question inputted by the user is directly received by a built-in microphone array of the intelligent device. As another scene example, the speech question which is sent by the user through a terminal device is received.

It should be noted that, the question answering processing method of the present disclosure aims at a condition that there are a plurality of candidate answers corresponding to the speech question and related to regions. If the speech question such as “who is Marx” is not related to a region, the number of candidate answers is generally one, and the candidate answer is directly provided to the user.

Therefore, it may be understood that, with respect to receiving the speech question and obtaining the answer set corresponding to the speech question, the answer set includes the plurality of candidate answers corresponding to the region identifications one by one. That is to say, the region identification has a corresponding candidate answer. For example, a region 1 corresponds to a candidate answer A, and a region 2 corresponds to a candidate answer B.

In embodiments of the present disclosure, there are a plurality of ways for obtaining the answer set corresponding to the speech question, examples of which are as follows.

In the first example, a category label of the speech question is obtained, and a knowledge range of candidate answers (such as a knowledge base of a category such as recipes or people) is determined based on the category label. In the knowledge range, a plurality of similar questions to the speech question are obtained, and text similarity calculation is performed for the speech question and the plurality of similar questions. The questions with higher similarity are obtained as a similar question set, and all answers in the similar question set are sorted and fed back to the user as a candidate answer set. Each candidate answer has a one-to-one correspondence with each region identification.

In the second example, an entity is extracted from the speech question, and entities related to such entity are queried in a knowledge map, and then a sub-graph is obtained based on such entity. After the sub-graph is obtained, for such entity, entities corresponding to all relationships with such entity as a candidate answer set of the speech question are fed back to the user. Each candidate answer has a one-to-one correspondence with each region identification.

It may be understood that, each region identification is obtained in advance. With respect to candidate answers corresponding to a speech question, the answer set is generated by performing one-to-one correspondence between each candidate answer and each region identification, and each speech question corresponds to an answer set. Different region identifications may correspond to same or different candidate answers.

As an example, for the speech question “how to cook tofu pudding”, an obtained answer set includes: r1-p1 and r2-p2. A region identification p1 in the r1-p1 represents a south region, and a candidate answer r1 corresponds to a cuisine method of sweet tofu pudding. A region identification p2 in the r2-p2 represents a north region, and a candidate answer r2 corresponds to a cuisine method of salty tofu pudding.

As another example, for the speech question “how to make a rice dumpling?”, an obtained answer set includes: r1-p1, r2-p2, r3*p3 and r4*p4, which respectively represent different region identifications, and different returned candidate answers.

At block 103, a current region identification of the user is obtained, and it is determined whether the answer set includes the current region identification.

At block 104, in a case that the answer set includes the current region identification, a first candidate answer corresponding to the current region identification is obtained, and the plurality of candidate answers sorted with the first candidate answer as a first place are fed back to the user.

In embodiments of the present disclosure, after the answer set corresponding to the speech question is obtained, the current region identification of the user is obtained. There are a plurality of ways for obtaining the current region identification of the user, which may be selected and set based on a requirement. As an example, current location information may be automatically obtained by a status module of the intelligent device, and the current region identification of the user is determined based on the current location information. As another example, a connection with the terminal device is established, location information sent by the terminal device is received, and the current region identification of the user is determined based on the location information. The way may be selected and set based on an application scene.

For example, the current location information automatically obtained by the status module of the intelligent device is XX Road, Haidian District, Beijing, and the current region identification of the user is determined as Beijing or a north region based on the current location information. In other words, the region identification may also be set based on a requirement, such as, identified by cities, provinces, north and south regions and countries, etc., and may also be set based on the application scene such as the speech question.

Further, the current region identification is matched with each region identification in the answer set, and it is determined whether the answer set includes the current region identification. In the case that the obtained answer set includes the current region identification, the first candidate answer corresponding to the current region identification may be obtained, and the plurality of candidate answers sorted with the first candidate answer as the first place may be fed back to the user.

For example, region identifications in the answer set are p1 to pn, and the candidate answers are r1 to m correspondingly. It is determined whether the current region identification belongs to p1 to pn. For example, when the current region identification is pn, the corresponding candidate answer m is sorted in the first place, and then a plurality of candidate answers sorted with the candidate answer m as the first place are fed back, such that different answers may be fed back based on different regions to which the users belong.

In conclusion, with the question answering processing method according to embodiments of the present disclosure, the speech question inputted by the user is received, the answer set corresponding to the speech question and the current region identification of the user are obtained, it is determined whether the answer set includes the current region identification, the first candidate answer corresponding to the current region identification is obtained in the case that the answer set includes the current region identification, and the plurality of candidate answers sorted with the first candidate answer as the first place are fed back to the user. In this way, for the same question, different answers may be fed back based on the different regions to which the users belong, and the weights of the answers may be automatically adjusted, thereby improving the intelligence of the intelligent device.

Based on the description for the above embodiment, after feeding the plurality of candidate answers sorted with the first candidate answer as the first place back to the user, the method also includes: increasing a weight of the first candidate answer corresponding to the current region identification when the user selects the first candidate answer.

In embodiments of the present disclosure, there are a plurality of ways for feeding the plurality of candidate answers sorted with the first candidate answer as the first place back to the user. For example, the plurality of candidate answers may be fed back to the user in an order, and may be fed back to the user in a broadcast form or in an interface display, which is selected based on an application scene. For example, the first candidate answer is displayed for the user in the broadcast form. In a practical application, when the user selects the first candidate answer, the user may give corresponding feedback, such as “OK”, not continuously asking similar questions, or pressing a related key such as a confirm key. Therefore, when the user selects the first candidate answer, the weight of the first candidate answer corresponding to the current region identification may be increased.

The weight of the first candidate answer corresponding to the current region identification may be changed, such as, from a coefficient 0.8 to a coefficient 0.85, or from a count value 80 to a count value 81. The weight may be set based on a requirement.

In embodiments of the present disclosure, the candidate answer having one-to-one correspondence with the region identification is a candidate answer with the highest weight after performing weight adjustment on the candidate answers selected by respective users for the same speech problem. In this way, the weight of the answer may be automatically adjusted, personalized replies in different regions are realized, different answers (i.e., answers that better meet the requirements of users) may be provided based on different regions for the same speech question, and the intelligence of the intelligent device is improved.

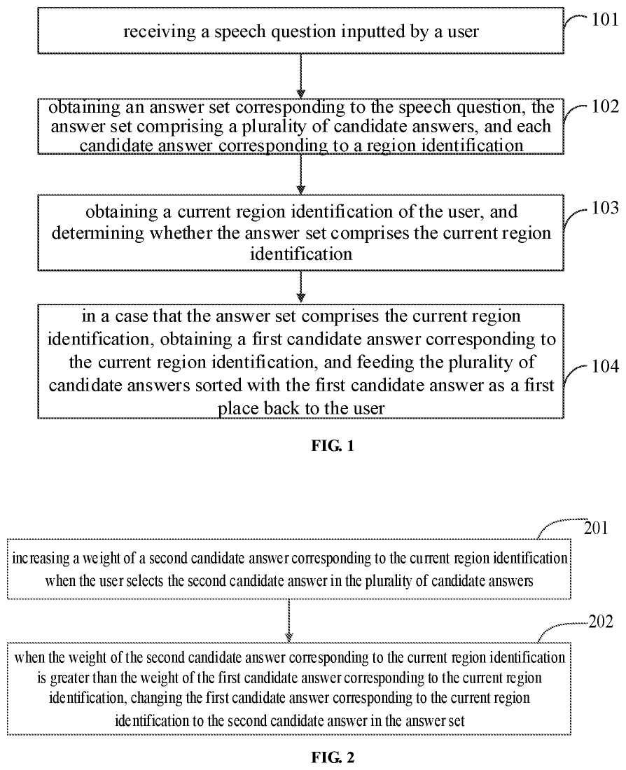

Based on the description of the above embodiments, it may also be understood that, the user may not select the first candidate answer. For example, when the first candidate answer is fed back to the user in the broadcast form, the user does not select the first candidate answer in a practical application, but performs a corresponding feedback, such as speaking “playing a second method”, or pressing a related key such as switching. That is, the user selects other candidate answer from the plurality of candidate answers. Therefore, there is a need to perform an adjustment. Detailed description will be made below to the adjustment with reference to FIG. 2.

FIG. 2 is a flow chart illustrating a question answering processing method according to a second embodiment of the present disclosure.

In detail, as illustrated in FIG. 2, the question answering processing method may also include the following after the action at block 104.

At block 201, a weight of a second candidate answer corresponding to the current region identification is increased when the user selects the second candidate answer in the plurality of candidate answers.

At block 202, when the weight of the second candidate answer corresponding to the current region identification is greater than the weight of the first candidate answer corresponding to the current region identification, the first candidate answer corresponding to the current region identification is changed to the second candidate answer in the answer set.

In this embodiment of the present disclosure, the user does not select the first candidate answer. The user selects other candidate answer from the plurality of candidate answers, such as selecting the second candidate answer in the plurality of candidate answers, and then the weight of the second candidate answer corresponding to the current region identification is increased. The weight of the second candidate answer corresponding to the current region identification may be increased, such as, from a coefficient 0.6 to a count value 0.65, or from a count value 60 to a count value 61, which may be set based on the requirement.

It should be understood that when a plurality of users select the second candidate answer in the plurality of candidate answers, the weight of the second candidate answer corresponding to the current region identification is increased continuously. When the weight of the second candidate answer corresponding to the current region identification is greater than the weight of the first candidate answer, it is represented that the users within the current region is more inclined to the second candidate answer for the speech question. In the answer set, the first candidate answer corresponding to the current region identification is changed to the second candidate answer, that is, the original first candidate answer is replaced with the second candidate answer.

In this way, by the feedback of the users, it may convenient to obtain the selection of the users in different regions for the candidate answers with respect to the same speech question. By the selection of the users, the intelligent device may gradually become smarter, and determine the preferences (i.e., the candidate answers corresponding to the current region identification) of the users in different regions.

Based on the description of the above embodiments, it may also be understood that, after determining whether the answer set includes the current region identification, when the answer set does not include the current region identification, there is no candidate answer corresponding to the current region identification. Therefore, a plurality of candidate answers may be directly provided to the user, and the weights of the candidate answers corresponding to the current region identification may be continuously adjusted based on the selection of the user, such that the candidate answer having the one-to-one correspondence with the current region identification may be determined and added to the answer set, where detailed description will be made below with reference to FIG. 3.

FIG. 3 is a flow chart illustrating a question answering processing method according to a third embodiment of the present disclosure.

In detail, as illustrated in FIG. 3, the question answering processing method may include the following after the action at block 103.

At block 301, the plurality of candidate answers are fed back to the user in a case that the answer set does not include the current region identification.

At block 302, a weight of a third candidate answer corresponding to the current region identification is increased based on the third candidate answer selected by the user from the plurality of candidate answers.

In this embodiment of the present disclosure, each region identification in the answer set does not match the current region identification, that is, there is no current region identification in the answer set. For example, the region identifications in the above answer set are p1 to pn, the candidate answers are correspondingly r1 to rn, and then it is determined whether the current region identification belongs to p1 to pn. For example, when the current region identification does not belong to p1 to pn, the plurality of candidate answers r1 to rn are returned to the user in a normal order.

Further, the user may select the third candidate answer from the plurality of candidate answers. For example, after the first candidate answer is broadcasted, the user feedbacks “OK”, and then when the user determines this candidate answer, the selected candidate answer is taken as the third candidate answer. The weight of the third candidate answer corresponding to the current region identification is increased. The weight of the third candidate answer corresponding to the current region identification may be changed, such as, from a coefficient 0.2 to a coefficient 0.25, or from a count value 10 to a count value 11, which may be set based on a requirement.

At block 303, when the weight of the third candidate answer corresponding to the current region identification is greater than a preset threshold, a correspondence between the third candidate answer and the current region identification is added to the answer set.

In this embodiment of the present disclosure, with the continuous interaction with the user, the weight of the third candidate answer corresponding to the current region identification is continuously adjusted. When the weight of the third candidate answer corresponding to the current region identification is greater than the preset threshold, the correspondence between the third candidate answer and the current region identification is added to the answer set. The preset threshold may be selected and set based on an application requirement.

In this way, by the feedback collected automatically, for different answers of the same question in a field, the candidate answer greater than the preset threshold is selected as the candidate answer in this field for one-to-one correspondence processing and added to the answer set, such that the candidate answer sorted in the first place is provided to the user directly based on the region identification, which further improves the interaction efficiency and meets the use requirement of the user.

To achieve the above embodiments, the present disclosure provides a question answering processing apparatus.

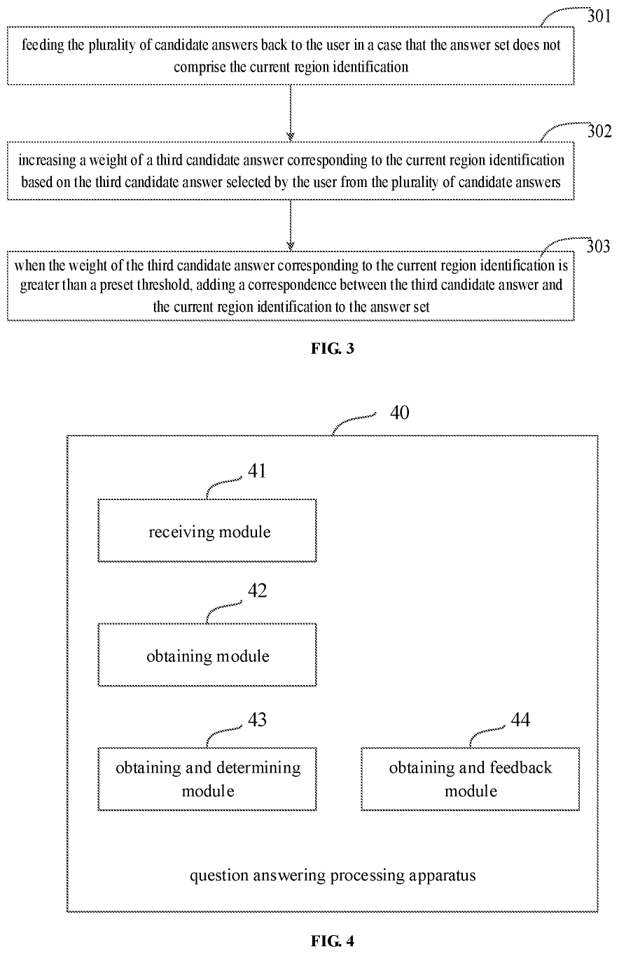

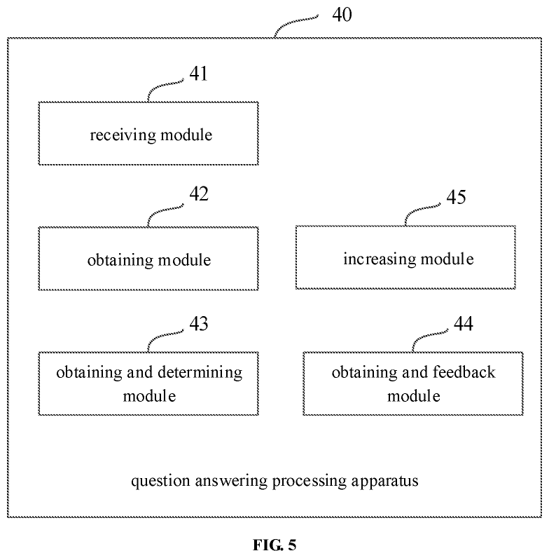

FIG. 4 is a block diagram illustrating a question answering processing apparatus according to a fourth embodiment of the present disclosure.

As illustrated in FIG. 4, the question answering processing apparatus 40 may include: a receiving module 41, an obtaining module 42, an obtaining and determining module 43, and an obtaining and feedback module 44.

The receiving module 41 is configured to receive a speech question inputted by a user.

The obtaining module 42 is configured to obtain an answer set corresponding to the speech question. The answer set includes a plurality of candidate answers, and each candidate answer corresponds to a region identification.

The obtaining and determining module 43 is configured to obtain a current region identification of the user, and to determine whether the answer set comprises the current region identification.

The obtaining and feedback module 44 is configured to obtain a first candidate answer corresponding to the current region identification in a case that the answer set includes the current region identification, and to feed the plurality of candidate answers sorted with the first candidate answer as a first place back to the user.

In an embodiment of the present disclosure, as illustrated in FIG. 5 the apparatus also includes an increasing module 45. Other modules of FIG. 5 are similar to those shown in FIG. 4 and described above.

The increasing module 45 is configured to increase a weight of the first candidate answer corresponding to the current region identification when the user selects the first candidate answer.

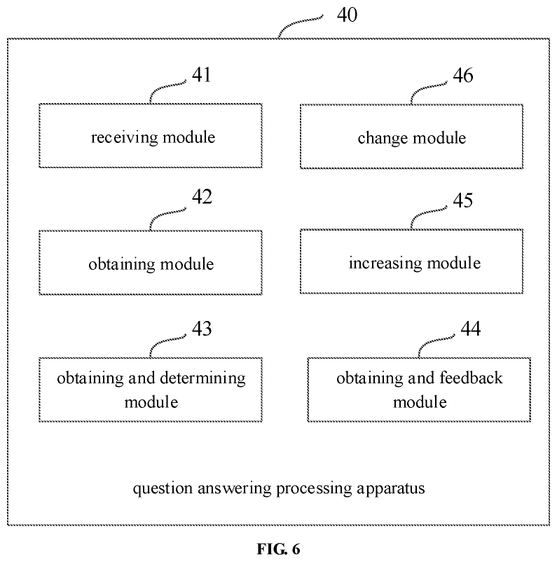

In an embodiment of the present disclosure, as illustrated in FIG. 6 the apparatus also includes a change module 46. Other modules of FIG. 5 are similar to those shown in FIG. 4 and described above.

The increasing module 45 may also be configured to increase a weight of a second candidate answer corresponding to the current region identification when the user selects the second candidate answer in the plurality of candidate answers.

The change module 46 is configured to change the first candidate answer corresponding to the current region identification to the second candidate answer in the answer set when the weight of the second candidate answer corresponding to the current region identification is greater than the weight of the first candidate answer corresponding to the current region identification.

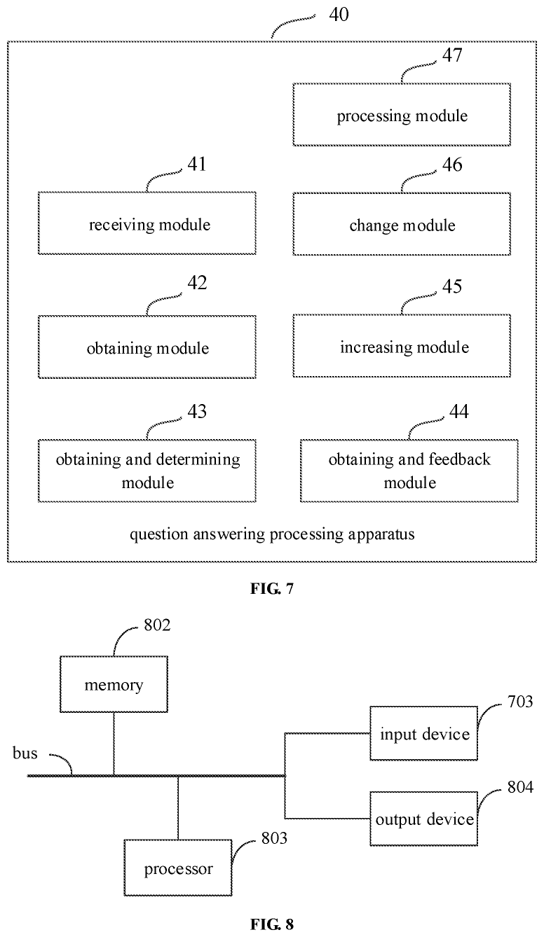

In an embodiment of the present disclosure, as illustrated in FIG. 7 the apparatus also includes a feedback module 47 and a processing module 48. Other modules of FIG. 5 are similar to those shown in FIG. 4 and described above.

The feedback module 47 is configured to feed the plurality of candidate answers back to the user in a case that the answer set does not include the current region identification.

The increasing module 45 may also be configured to increase a weight of a third candidate answer corresponding to the current region identification based on the third candidate answer selected by the user from the plurality of candidate answers.

The processing module 48 is configured to add a correspondence between the third candidate answer and the current region identification to the answer set when the weight of the third candidate answer corresponding to the current region identification is greater than a preset threshold.

In conclusion, with the question answering processing apparatus according to embodiments of the present disclosure, the speech question inputted by the user is received, the answer set corresponding to the speech question and the current region identification of the user are obtained, it is determined whether the answer set includes the current region identification, the first candidate answer corresponding to the current region identification is obtained in the case that the answer set includes the current region identification, and the plurality of candidate answers sorted with the first candidate answer as the first place are fed back to the user. When the user selects the first candidate answer, the weight of the first candidate answer corresponding to the current region identification is increased. In this way, the answer may be fed back based on the region to which the user belongs, and the weight of the answer is automatically adjusted, to improve the intelligence of the intelligent device.

According to embodiments of the present disclosure, the present disclosure also provides an electronic device and a readable storage medium.

As illustrated in FIG. 8, FIG. 8 is a block diagram illustrating an electronic device capable of implementing a question answering processing method according to embodiments of the present disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, an intelligent phone, a wearable device and other similar computing device. The components, connections and relationships of the components, and functions of the components illustrated herein are merely examples, and are not intended to limit the implementation of the present disclosure described and/or claimed herein.

As illustrated in FIG. 8, the electronic device includes: one or more processors 801, a memory 802, and interfaces for connecting various components, including a high-speed interface and a low-speed interface. Various components are connected to each other by different buses, and may be mounted on a common main board or in other ways as required. The processor may process instructions executed within the electronic device, including instructions stored in or on the memory to display graphical information of the GUI (graphical user interface) on an external input/output device (such as a display device coupled to an interface). In other implementations, a plurality of processors and/or a plurality of buses may be used together with a plurality of memories if desired. Similarly, a plurality of electronic devices may be connected, and each device provides some necessary operations (for example, as a server array, a group of blade servers, or a multiprocessor system). In FIG. 8, a processor 801 is taken as an example.

The memory 802 is a non-transitory computer readable storage medium provided by the present disclosure. The memory is configured to store instructions executable by at least one processor, to enable the at least one processor to execute a question answering processing method provided by the present disclosure. The non-transitory computer readable storage medium provided by the present disclosure is configured to store computer instructions. The computer instructions are configured to enable a computer to execute the question answering processing method provided by the present disclosure.

As the non-transitory computer readable storage medium, the memory 802 may be configured to store non-transitory software programs, non-transitory computer executable programs and modules, such as program instructions/modules (such as, the receiving module 41, the obtaining module 42, the obtaining and determining module 43 and the obtaining and feedback module 44 illustrated in FIG. 4) corresponding to the question answering processing method according to embodiments of the present disclosure. The processor 801 executes various functional applications and data processing of the server by operating non-transitory software programs, instructions and modules stored in the memory 802, that is, implements the question answering processing method according to the above method embodiment.

The memory 802 may include a storage program region and a storage data region. The storage program region may store an application required by an operating system and at least one function. The storage data region may store data created according to usage of the electronic device for performing the question answering processing. In addition, the memory 802 may include a high-speed random-access memory, and may also include a non-transitory memory, such as at least one disk memory device, a flash memory device, or other non-transitory solid-state memory device. In some embodiments, the memory 802 may alternatively include memories remotely located to the processor 801, and these remote memories may be connected to the electronic device capable of implementing the question answering processing method via a network. Examples of the above network include, but are not limited to, an Internet, an intranet, a local area network, a mobile communication network and combinations thereof.

The electronic device capable of implementing the question answering processing method may also include: an input apparatus 803 and an output device 804. The processor 801, the memory 802, the input device 803, and the output device 804 may be connected via a bus or in other means. In FIG. 8, the bus is taken as an example.

The input device 803 may receive inputted digital or character information, and generate key signal input related to user setting and function control of the electronic device capable of implementing the question answering processing method, such as a touch screen, a keypad, a mouse, a track pad, a touch pad, an indicator stick, one or more mouse buttons, a trackball, a joystick and other input device. The output device 804 may include a display device, an auxiliary lighting device (e.g., LED), a haptic feedback device (e.g., a vibration motor), and the like. The display device may include, but be not limited to, a liquid crystal display (LCD), a light emitting diode (LED) display, and a plasma display. In some embodiments, the display device may be the touch screen.

The various implementations of the system and technologies described herein may be implemented in a digital electronic circuit system, an integrated circuit system, an application specific ASIC (application specific integrated circuit), a computer hardware, a firmware, a software, and/or combinations thereof. These various implementations may include: being implemented in one or more computer programs. The one or more computer programs may be executed and/or interpreted on a programmable system including at least one programmable processor. The programmable processor may be a special purpose or general purpose programmable processor, may receive data and instructions from a storage system, at least one input device, and at least one output device, and may transmit the data and the instructions to the storage system, the at least one input device, and the at least one output device.

These computing programs (also called programs, software, software applications, or codes) include machine instructions of programmable processors, and may be implemented by utilizing high-level procedures and/or object-oriented programming languages, and/or assembly/machine languages. As used herein, the terms “machine readable medium” and “computer readable medium” refer to any computer program product, device, and/or apparatus (such as, a magnetic disk, an optical disk, a memory, a programmable logic device (PLD)) for providing machine instructions and/or data to a programmable processor, including machine readable medium that receives machine instructions as a machine-readable signal. The term “machine-readable signal” refers to any signal for providing the machine instructions and/or data to the programmable processor.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components, or the front-end component.

Components of the system may be connected to each other through digital data communication in any form or medium (such as, a communication network). Examples of the communication network include a local area network (LAN), a wide area networks (WAN), and the Internet.

The computer system may include a client and a server. The client and the server are generally remote from each other and usually interact via the communication network. A relationship between client and server is generated by computer programs operated on a corresponding computer and having a client-server relationship with each other.

With the technical solution according to embodiments of the present disclosure, the speech question inputted by the user is received, the answer set corresponding to the speech question and the current region identification of the user are obtained, it is determined whether the answer set includes the current region identification, the first candidate answer corresponding to the current region identification is obtained in the case that the answer set includes the current region identification, and the plurality of candidate answers sorted with the first candidate answer as the first place are fed back to the user. When the user selects the first candidate answer, the weight of the first candidate answer corresponding to the current region identification is increased. In this way, the answer may be fed back based on the region to which the user belongs, and the weight of the answer is automatically adjusted, to improve the intelligence of the intelligent device.

It should be understood that, steps may be reordered, added or deleted by utilizing flows in the various forms illustrated above. For example, the steps described in the present disclosure may be executed in parallel, sequentially or in different orders, so long as desired results of the technical solution disclosed in the present disclosure may be achieved, there is no limitation here.

What is claimed is:

1. A question answering processing method, comprising:
receiving a speech question inputted by a user;
obtaining an answer set corresponding to the speech question, the answer set comprising a plurality of candidate answers, and each candidate answer corresponding to a region identification;
obtaining a current region identification of the user, and determining whether the answer set comprises the current region identification; and
in a case that the answer set comprises the current region identification, obtaining a first candidate answer corresponding to the current region identification, and feeding the plurality of candidate answers sorted with the first candidate answer as a first place back to the user.

2. The method of claim 1, further comprising:
after feeding the plurality of candidate answers sorted with the first candidate answer as the first place back to the user, increasing a weight of the first candidate answer corresponding to the current region identification when the user selects the first candidate answer.

3. The method of claim 1, further comprising:
after feeding the plurality of candidate answers sorted with the first candidate answer as the first place back to the user, increasing a weight of a second candidate answer corresponding to the current region identification when the user selects the second candidate answer in the plurality of candidate answers.

4. The method of claim 3, further comprising:
when the weight of the second candidate answer corresponding to the current region identification is greater than the weight of the first candidate answer corresponding to the current region identification, changing the first candidate answer corresponding to the current region identification to the second candidate answer in the answer set.

5. The method of claim 1, further comprising:
after determining whether the answer set comprises the current region identification:
feeding the plurality of candidate answers back to the user in a case that the answer set does not comprise the current region identification; and
increasing a weight of a third candidate answer corresponding to the current region identification based on the third candidate answer selected by the user from the plurality of candidate answers.

6. The method of claim 5, further comprising:
when the weight of the third candidate answer corresponding to the current region identification is greater than a preset threshold, adding a correspondence between the third candidate answer and the current region identification to the answer set.

7. A question answering processing apparatus, comprising a non-transitory computer-readable medium including computer-executable instructions stored thereon, and an instruction execution system which is configured by the instructions to implement:
a receiving module, configured to receive a speech question inputted by a user;
an obtaining module, configured to obtain an answer set corresponding to the speech question, the answer set comprising a plurality of candidate answers, and each candidate answer corresponding to a region identification;
an obtaining and determining module, configured to obtain a current region identification of the user, and to determine whether the answer set comprises the current region identification; and
an obtaining and feedback module, configured to obtain a first candidate answer corresponding to the current region identification in a case that the answer set comprises the current region identification, and to feed the plurality of candidate answers sorted with the first candidate answer as a first place back to the user.

8. The apparatus of claim 7, wherein the instruction execution system is further configured by the instructions to implement:
an increasing module, configured to increase a weight of the first candidate answer corresponding to the current region identification when the user selects the first candidate answer.

9. The apparatus of claim 7, wherein the increasing module is further configured to increase a weight of a second candidate answer corresponding to the current region identification when the user selects the second candidate answer in the plurality of candidate answers.

10. The apparatus of claim 9, wherein the instruction execution system is further configured by the instructions to implement:
a change module, configured to change the first candidate answer corresponding to the current region identification to the second candidate answer in the answer set when the weight of the second candidate answer corresponding to the current region identification is greater than the weight of the first candidate answer corresponding to the current region identification.

11. The apparatus of claim 7, wherein the instruction execution system is further configured by the instructions to implement: a feedback module, configured to feed the plurality of candidate answers back to the user in a case that the answer set does not comprise the current region identification; and
the increasing module is further configured to increase a weight of a third candidate answer corresponding to the current region identification based on the third candidate answer selected by the user from the plurality of candidate answers.

12. The apparatus of claim 11, wherein the instruction execution system is further configured by the instructions to implement:
a processing module, configured to add a correspondence between the third candidate answer and the current region identification to the answer set when the weight of the third candidate answer corresponding to the current region identification is greater than a preset threshold.

13. A non-transitory computer readable storage medium having computer instructions stored thereon, wherein when the computer instructions are executed by a processor in a computer, the processor is caused to implement a question answering processing method, and the method comprises:
receiving a speech question inputted by a user;
obtaining an answer set corresponding to the speech question, the answer set comprising a plurality of candidate answers, and each candidate answer corresponding to a region identification;
obtaining a current region identification of the user, and determining whether the answer set comprises the current region identification; and
in a case that the answer set comprises the current region identification, obtaining a first candidate answer corresponding to the current region identification, and feeding the plurality of candidate answers sorted with the first candidate answer as a first place back to the user.
